(19) United States
(12) Patent Application Publication
(10) Pub. No.: US 2026/0312016 A1
(43) Pub. Date: Oct. 8, 2026

(54) NEGATIVE ELECTRODE FOR NON-AQUEOUS ELECTROLYTE SECONDARY BATTERY

(71) Applicant: TOYOTA JIDOSHA KABUSHIKI KAISHA, Toyota-shi (JP)

(72) Inventor: Daiki MAEDA, Toyota-shi (JP)

(73) Assignee: TOYOTA JIDOSHA KABUSHIKI KAISHA, Toyota-shi (JP)

(21) Appl. No.: 19/547,913

(22) Filed: Feb. 24, 2026

(30) Foreign Application Priority Data
Apr. 3, 2025 (JP) 2025-062019

(51) Int. Cl. H01M 4/36; H01M 4/02; H01M 4/587

(52) U.S. Cl. CPC H01M 4/366; H01M 4/587; H01M 2004/027

(57) ABSTRACT

A negative electrode for a non-aqueous electrolyte secondary battery includes a current collector, a first active material layer, a second active material layer, and a third active material layer in this order. The first active material layer and the third active material layer each independently contain at least one of natural graphite or artificial graphite. The second active material layer contains natural graphite and a Si-based active material. The natural graphite in the second active material layer is aligned in a thickness direction of the second active material layer.

### CROSS-REFERENCE TO RELATED APPLICATION

This application claims priority to Japanese Patent Application No. 2025-062019 filed on Apr. 3, 2025. The disclosure of the above-identified application, including the specification, drawings, and claims, is incorporated by reference herein in its entirety.

### BACKGROUND

### 1. Technical Field

The present disclosure relates to a negative electrode for a non-aqueous electrolyte secondary battery.

### 2. Description of Related Art

Korean Patent Application Publication No. 10-2022-0012577 (KR 20220012577 A) discloses a negative electrode having a three-layer structure including a graphite-based active material and a Si-based active material.

### SUMMARY

The Si-based active material has a larger specific capacity than the carbon-based active material (natural graphite, artificial graphite). On the other hand, the Si-based active material has a property of being significantly expanded during charging. The active material layer may collapse in a part thereof due to the expansion of the active material layer. In order to reduce the expansion of the active material layer due to the Si-based active material, for example, a consideration is made to use a mixture of the Si-based active material and the carbon-based active material.

For example, in KR 20220012577 A, in the three-layer structure of an upper layer, a middle layer, and a lower layer, a study is conducted to reduce the expansion by unevenly distributing the Si-based active material in the middle layer and the lower layer. However, there is still room for improvement.

The present disclosure can reduce the expansion.

Hereinafter, technical configurations and effects of an embodiment of the present disclosure will be described. However, an action mechanism includes an estimation. The action mechanism does not limit the technical scope of the present disclosure.

1. A negative electrode for a non-aqueous electrolyte secondary battery according to one aspect of the present disclosure includes
a current collector, a first active material layer, a second active material layer, and a third active material layer, in an order of the current collector, the first active material layer, and the second active material layer.
The first active material layer and the third active material layer each independently contain at least one of natural graphite or artificial graphite.
The second active material layer contains natural graphite and a Si-based active material.
The natural graphite in the second active material layer is aligned in a thickness direction of the second active material layer.

FIG. 1 is a sectional conceptual diagram showing a first laminated structure in the present embodiment. In the drawings of the present disclosure, “G” indicates any graphite material. “Si” indicates the Si-based active material. The negative electrode 20 includes a current collector 21, a first active material layer 22a (lower layer), a second active material layer 22b (middle layer), and a third active material layer 22c (upper layer) in this order. Each of the layers includes any graphite material. The Si-based active material is unevenly distributed in the middle layer and the lower layer. In the first laminated structure, since the Si-based active material is spaced from the surface of the negative electrode 20, the expansion in the thickness direction is expected to be reduced. However, the expansion in the thickness direction may not be sufficiently reduced. In addition, the expansion also occurs in an in-plane direction. In the first laminated structure, the expansion in the in-plane direction may not be reduced. Due to the expansion in the in-plane direction, the structural destruction of the negative electrode 20 may progress.

FIG. 2 is a sectional conceptual diagram showing a second laminated structure in the present embodiment. In the second laminated structure, the Si-based active material is unevenly distributed in the second active material layer 22b (middle layer). The lower layer and the upper layer are expected to absorb the expansion of the middle layer. However, in the second laminated structure, the expansion of the middle layer in the in-plane direction may not be reduced.

FIG. 3 is a sectional conceptual diagram showing a third laminated structure in the present embodiment. In the drawings of the present disclosure, “AG” indicates artificial graphite. In the third laminated structure, the Si-based active material is also unevenly distributed in the second active material layer 22b (middle layer). The middle layer further contains artificial graphite. However, in the third laminated structure, the expansion of the middle layer in the in-plane direction may not be reduced.

FIG. 4 is a sectional conceptual diagram showing a fourth laminated structure in the present embodiment. In the drawings of the present disclosure, a circular element indicates an unaligned active material. An elliptical element indicates an active material aligned in the thickness direction. In the fourth laminated structure, the artificial graphite of the middle layer is aligned in the thickness direction. However, in the fourth laminated structure, the expansion of the middle layer in the in-plane direction may not be reduced.

FIG. 5 is a sectional conceptual diagram showing a fifth laminated structure in the present embodiment. In the drawings of the present disclosure, “NG” indicates natural graphite. In the fifth laminated structure, the middle layer further contains natural graphite. However, in the fifth laminated structure, the expansion of the middle layer in the in-plane direction may not be reduced.

FIG. 6 is a sectional conceptual diagram showing a sixth laminated structure in the present embodiment. In the sixth laminated structure, the natural graphite of the middle layer is aligned in the thickness direction. With new findings of the present disclosure, the expansion of the middle layer in the in-plane direction is expected to be reduced by aligning the natural graphite of the middle layer in the thickness direction. Further, improvement in the expansion absorption action in the thickness direction by the upper layer and the lower layer is also expected. Therefore, in the sixth laminated structure, the expansion of the entire negative electrode 20 is expected to be significantly reduced by synergistically reducing the expansion in the thickness direction and the in-plane direction.

2. The negative electrode according to “1” may include, for example, the following configuration.
The natural graphite in the second active material layer has an alignment angle of 30° or more.
The alignment angle indicates an acute angle between a major axis diameter of a particle and a surface of the current collector.

The alignment angle is an indicator of the alignment properties. As the alignment angle is closer to 90°, the particles are considered to be more strongly aligned in the thickness direction. By setting the alignment angle of the natural graphite in the middle layer to 30° or more, the reduction of the expansion of the negative electrode is expected.

3. The negative electrode according to “1” or “2” may include, for example, the following configuration.
The first active material layer contains the natural graphite.
The third active material layer contains the artificial graphite and the natural graphite.
A relationship of “θ₁<θ₃<θ₂” is satisfied.
“θ₁” indicates an alignment angle of the natural graphite in the first active material layer.
“θ₂” indicates an alignment angle of the natural graphite in the second active material layer.
“θ₃” indicates an alignment angle of the natural graphite in the third active material layer.

FIG. 7 is a sectional conceptual diagram showing a seventh laminated structure in the present embodiment. The first active material layer 22a (lower layer) contains natural graphite. The third active material layer 22c (upper layer) contains artificial graphite and aligned natural graphite. By increasing the alignment of the natural graphite in the order of the lower layer, the upper layer, and the middle layer, reduction of the resistance is expected in addition to reduction of the expansion. The aligned natural graphite can provide a diffusion path of Li ions from the upper layer to the lower layer of the negative electrode 20. In the lower layer, the diffusion path of Li ions that spreads in the in-plane direction can be provided by the unaligned natural graphite. The resistance is considered to be reduced by connecting the diffusion paths of the upper layer, the middle layer, and the lower layer.

4. The negative electrode according to any one of “1” to “3” may include, for example, the following configuration.
The first active material layer, the second active material layer, and the third active material layer each independently further contain a binder.
A relationship of M_{B3}<M_{B1}<M_{B2} is satisfied.
“M_{B1}” indicates a mass fraction of the binder in the first active material layer.
“M_{B2}” indicates a mass fraction of the binder in the second active material layer.
“M_{B3}” indicates a mass fraction of the binder in the third active material layer.

The structural destruction due to the expansion and contraction of the Si-based active material is expected to be hindered by setting the mass fraction “M_{B2}” of the binder in the middle layer including the Si-based active material to be relatively high. The permeation and diffusion of Li ions from the negative electrode surface are expected to be promoted by setting the mass fraction “M_{B3}” of the binder in the upper layer to be relatively low. The improvement in the peel strength is expected by setting the mass fraction “M_{B1}” of the binder in the lower layer in contact with the current collector to be relatively high.

5. A negative electrode for a non-aqueous electrolyte secondary battery according to one aspect of the present disclosure includes
a current collector, a first active material layer, a second active material layer, and a third active material layer in an order of the current collector, the first active material layer, and the second active material layer.
The first active material layer contains natural graphite and a binder.
The second active material layer contains natural graphite, a Si-based active material, and a binder.
The third active material layer contains artificial graphite, natural graphite, and a binder.
The natural graphite in the second active material layer has an alignment angle of 30° or more.
The alignment angle indicates an acute angle between a major axis diameter of a particle and a surface of the current collector.
A relationship of “θ₁<θ₃<θ₂” is satisfied.
“θ₁” indicates an alignment angle of the natural graphite in the first active material layer.
“θ₂” indicates an alignment angle of the natural graphite in the second active material layer.
“θ₃” indicates an alignment angle of the natural graphite in the third active material layer.
A relationship of M_{B3}<M_{B1}<M_{B2} is satisfied.
“M_{B1}” indicates a mass fraction of the binder in the first active material layer.
“M_{B2}” indicates a mass fraction of the binder in the second active material layer.
“M_{B3}” indicates a mass fraction of the binder in the third active material layer.
A relationship of “φ₁<φ₃<φ₂” is satisfied.
“φ₁” indicates a void ratio of the first active material layer.
“φ₂” indicates a void ratio of the second active material layer.
“φ₃” indicates a void ratio of the third active material layer.

The voids are expected to absorb the expansion of the Si-based active material by setting the void ratio “φ₂” in the middle layer including the Si-based active material to be relatively high. The permeation and diffusion of Li ions from the negative electrode surface are expected to be promoted by setting the void ratio “φ₃” in the upper layer to be relatively high. The improvement in the peel strength is expected by setting the void ratio “φ₁” in the lower layer to be relatively low.

Hereinafter, an embodiment of the present disclosure (hereinafter, may be abbreviated as “the present embodiment”) will be described. Here, the present embodiment does not limit the technical scope of the present disclosure. The present embodiment is exemplary in all aspects. The present embodiment is not restrictive. The technical scope of the present disclosure includes all changes within the meaning and the scope that are equivalent to the description of CLAIMS. For example, extracting arbitrary configurations from the present embodiment and arbitrarily combining the configurations are preconceived from the first.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a sectional conceptual diagram showing a first laminated structure in the present embodiment;

FIG. 2 is a sectional conceptual diagram showing a second laminated structure in the present embodiment;

FIG. 3 is a sectional conceptual diagram showing a third laminated structure in the present embodiment;

FIG. 4 is a sectional conceptual diagram showing a fourth laminated structure in the present embodiment;

FIG. 5 is a sectional conceptual diagram showing a fifth laminated structure in the present embodiment;

FIG. 6 is a sectional conceptual diagram showing a sixth laminated structure in the present embodiment;

FIG. 7 is a sectional conceptual diagram showing a seventh laminated structure in the present embodiment;

FIG. 8 is a conceptual sectional view for describing an alignment angle in the present embodiment;

FIG. 9 is a conceptual diagram showing an example of a non-aqueous electrolyte secondary battery in the present embodiment; and

FIG. 10 is a sectional conceptual diagram showing an eighth laminated structure in the present embodiment.

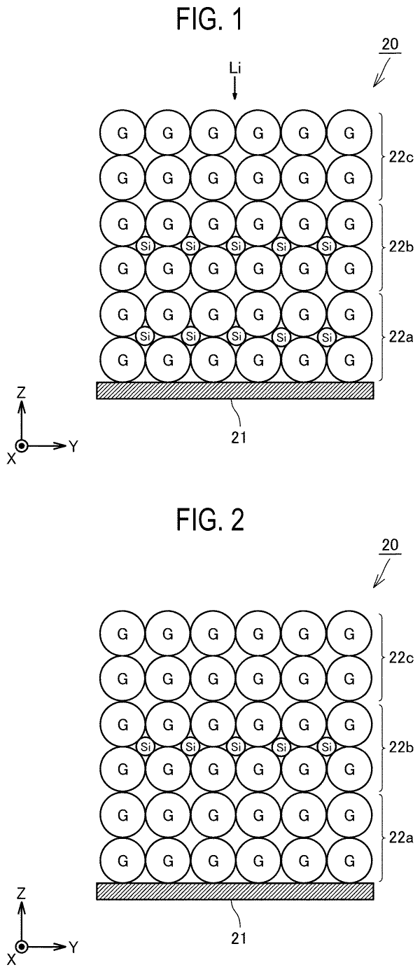

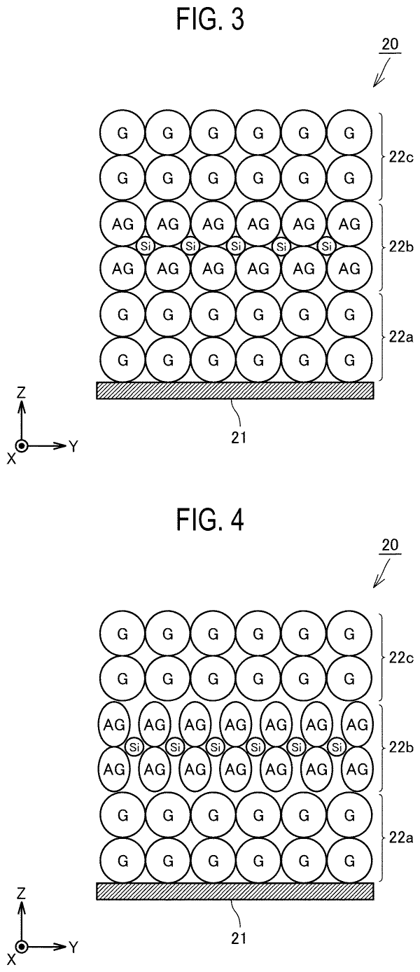

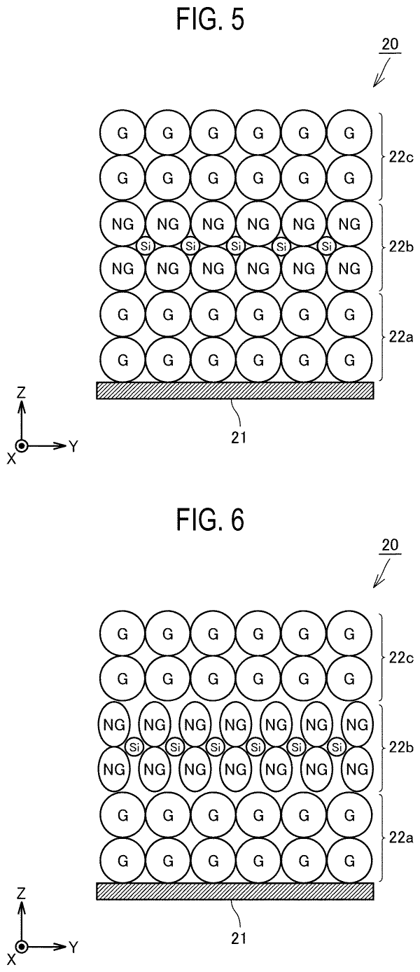

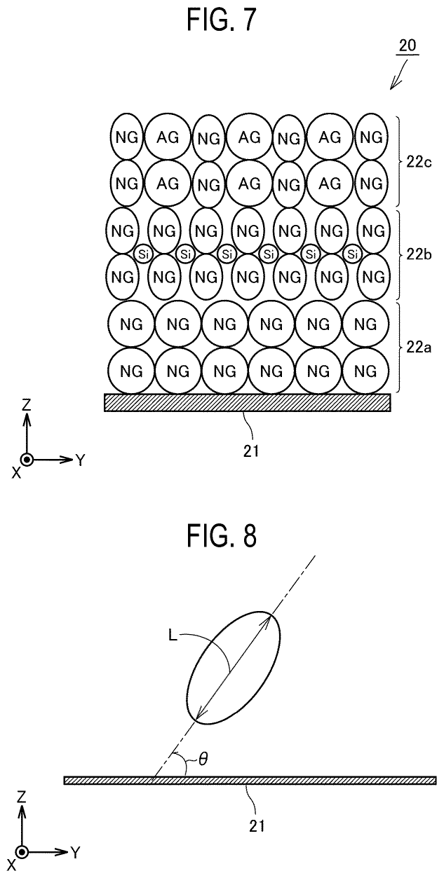

### DETAILED DESCRIPTION OF EMBODIMENTS

### Terms and Phrases

The terms “comprising”, “including”, “having”, and modifications thereof are open-ended expressions. A configuration expressed in an open-ended manner may further include or may not include an additional element in addition to the essential element. The description of “consisting of” is a closed-ended expression. However, even in a configuration expressed in a closed-ended manner, an additional element that is usually an impurity or is irrelevant to the target technology may be included. The description of “substantially consisting of” is a semi-closed-ended expression. In a configuration expressed in a semi-closed-ended manner, addition of an element that does not substantially affect the basic and novel characteristics of the target technology is allowed.

Geometric terms should not be construed in a strict sense. Examples of the geometric terms include “parallel”, “perpendicular”, and “orthogonal”. For example, a direction, an angle, a distance, or the like may be relatively displaced within a range in which substantially the same or similar functions are obtained. The geometric terms may include a tolerance, an error, or the like in design, operation, manufacturing, or the like. The dimensional relationships in each of the drawings may not match the actual dimensional relationships. For the understanding of the reader, the dimensional relationships in each of the drawings may be changed. For example, a length, a width, and a thickness may be changed. Some configurations may be omitted.

Unless otherwise specified, the singular form is not limited to a single (one) element. The singular form also includes a plurality of elements.

The “artificial graphite” indicates graphite synthesized by artificial heat treatment. The artificial graphite is also referred to as synthetic graphite (SG). The “natural graphite” indicates graphite generated in nature. The natural graphite includes flake graphite. The flake graphite may be rounded such that an end of the particle is bent. The “Si-based active material” contains Si (or an Si compound, an Si alloy, or the like) that can be alloyed with Li. The Si-based active material may contain, for example, at least one selected from the group consisting of pure Si, a Si-based alloy, SiO, and Si—C. The “Si—C” indicates a composite particle containing at least one of Si or SiO, and carbon. For example, Si may be supported on the carbon material.

The “particle diameter” is specified by a microscope method. The particle diameter indicates an arithmetic average of a long side and a short side in a minimum bounding rectangle (MBR) of a two-dimensional image of the particle. The “average particle diameter” indicates an arithmetic average of particle diameters of 100 particles randomly extracted. Various image analyses in the present embodiment may be performed by software. For example, “ImageJ” may be used.

The “aspect ratio” indicates a ratio of the long side to the short side of the MBR.

An arithmetic average of aspect ratios of 100 particles randomly extracted is adopted.

FIG. 8 is a conceptual sectional view for describing an alignment angle in the present disclosure. The “alignment angle” is an acute angle “θ” between the major axis diameter “L” of the particle (for example, the natural graphite) and the surface of the current collector 21 in a cross-sectional scanning electron microscope (SEM) image of the negative electrode 20. The alignment angle can take a value of 0° to 90°. The major axis diameter indicates a maximum Feret diameter of the particle. An arithmetic average of alignment angles of 100 particles randomly extracted is adopted.

The “basis weight” indicates a mass per unit area.

The “void ratio” is specified by an image analysis method. The void and the solid are discriminated by binarizing the cross-sectional SEM image of each layer. The void ratio is obtained by dividing the total area (total pixels) of the voids by the area of the entire layer.

The “active material layer” is a general term for the first active material layer, the second active material layer, and the third active material layer.

### Non-Aqueous Electrolyte Secondary Battery

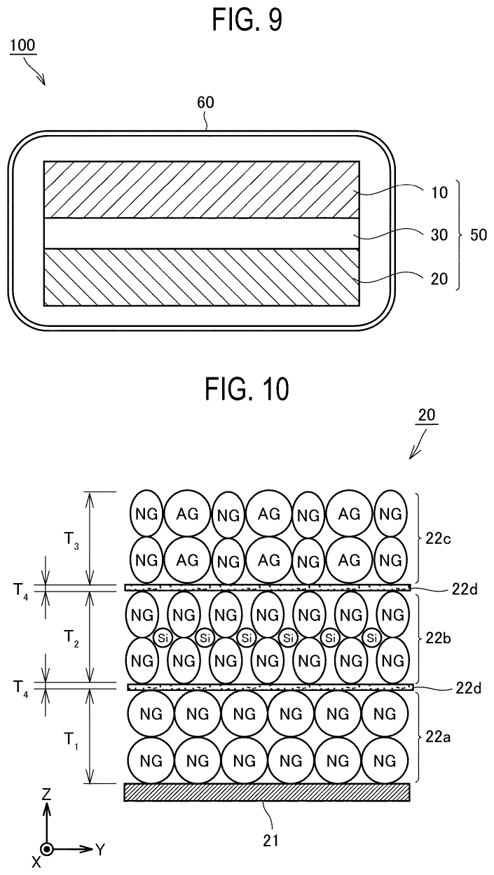

FIG. 9 is a conceptual diagram showing an example of a non-aqueous electrolyte secondary battery in the present embodiment. The non-aqueous electrolyte secondary battery 100 may include, for example, a power generation element 50 and a case 60. The case 60 accommodates the power generation element 50. The case 60 may be, for example, a container made of metal or a pouch made of an aluminum laminate film. The power generation element 50 may include, for example, a positive electrode 10, a negative electrode 20, a separator 30, and a non-aqueous electrolyte (not shown). The power generation element 50 may be, for example, a wound type or a laminated type. The power generation element 50 may have a monopolar structure or a bipolar structure. The separator 30 can electrically separate the positive electrode 10 from the negative electrode 20. The separator 30 may include, for example, a porous film made of a resin. The non-aqueous electrolyte is a Li ion conductor. The non-aqueous electrolyte may include, for example, a Li salt and an organic solvent. The non-aqueous electrolyte may be, for example, impregnated in the separator 30. The non-aqueous electrolyte may include, for example, a polymer electrolyte, a gel electrolyte, and a solid electrolyte. The solid electrolyte may include, for example, a sulfide solid electrolyte, an oxide solid electrolyte, and a halide solid electrolyte. The positive electrode 10 contains a positive electrode active material. The positive electrode active material may include, for example, a lithium transition metal composite oxide (Li[NiCoMn]O₂) or a lithium phosphate compound (Li[FeMn]PO₄). The description of [NiCoMn], [FeMn], and the like indicates that the total of the compositional ratios of the components in [] is “1”. The compositional ratio of each component is optional as long as the total is 1. For example, the compositional ratio of some components may be zero.

### Negative Electrode

FIG. 10 is a sectional conceptual diagram showing an eighth laminated structure in the present embodiment. The negative electrode 20 may have a sheet-like shape, for example. The negative electrode 20 has a multilayer structure. The negative electrode 20 includes the current collector 21, the first active material layer 22a, the second active material layer 22b, and the third active material layer 22c in this order in the thickness direction. The first active material layer 22a may be disposed on a part of the surface of the current collector 21 or may be disposed on the entire surface. The first active material layer 22a may be disposed on only one surface of the current collector 21 or may be disposed on both surfaces of the current collector 21. The current collector 21 may include, for example, a metal foil (a Cu foil, a Ni foil, or the like) or a conductive resin layer. The current collector 21 may have a thickness of, for example, 1 μm to 100 μm.

The negative electrode 20 may further include any element as long as the first active material layer 22a, the second active material layer 22b, and the third active material layer 22c are included. For example, a fourth and a fifth active material layer (not shown) may be further included at any position in the thickness direction. For example, a conductive layer, an adhesion layer (both not shown), or the like may be disposed between the first active material layer 22a and the current collector 21. For example, a ceramic particle layer (not shown) or the like may be disposed on the surface of the third active material layer 22c. For example, a binder layer 22d may be disposed between any one or more layers.

Each layer may be, for example, a coating layer. The coating layer indicates a layer formed by applying a coating material. Each coating material may be applied substantially simultaneously or may be applied sequentially. For example, the graphite included in the coating layer can be aligned in the thickness direction by applying a magnetic field to the coating layer before the coating material is dried. For example, the alignment angle may be adjusted by the strength of the magnetic field, the concentration of the coating material, the pressing pressure, and the like.

Layers may each independently have any thickness. The thicknesses of the layers may be substantially the same or different from each other. For example, the thickness “T₁” of the first active material layer 22a, the thickness “T₂” of the second active material layer 22b, and the thickness “T₃” of the third active material layer 22c may satisfy a relationship of “T₁≤T₃<T₂”, “T₂<T₁≤T₃”, or the like. A ratio of the minimum thickness to the maximum thickness among the three layers may be, for example, 0.9 or less, 0.8 or less, 0.7 or less, 0.6 or less, 0.5 or less, 0.4 or less, 0.3 or less, 0.2 or less, or 0.1 or less. A ratio of the minimum thickness to the maximum thickness among the three layers may be, for example, 0.1 or more, 0.2 or more, 0.3 or more, 0.4 or more, 0.5 or more, 0.6 or more, 0.7 or more, 0.8 or more, or 0.9 or more. The thicknesses of the layers may be each independently, for example, 10 μm or more, 30 μm or more, 50 μm or more, 100 μm or more, 150 μm or more, 200 μm or more, 250 μm or more, or 300 μm or more. The thicknesses of the layers may be each independently, for example, 1 mm or less, 500 μm or less, 400 μm or less, 300 μm or less, or 200 μm or less.

Layers may each independently have any basis weight. The basis weights of the layers may be substantially the same or different from each other. For example, the basis weight “W₁” of the first active material layer 22a, the basis weight “W₂” of the second active material layer 22b, and the basis weight “W₃” of the third active material layer 22c may satisfy a relationship of “W₁≤W₃<W₂”, “W₂<W₁≤W₃”, or the like. A ratio of the minimum basis weight to the maximum basis weight among the three layers may be, for example, 0.9 or less, 0.8 or less, 0.7 or less, 0.6 or less, 0.5 or less, 0.4 or less, 0.3 or less, 0.2 or less, or 0.1 or less. A ratio of the minimum basis weight to the maximum basis weight among the three layers may be, for example, 0.1 or more, 0.2 or more, 0.3 or more, 0.4 or more, 0.5 or more, 0.6 or more, 0.7 or more, 0.8 or more, or 0.9 or more. The basis weights of the layers may be each independently, for example, 1 mg/cm² or more, 5 mg/cm² or more, 10 mg/cm² or more, or 20 mg/cm² or more. The basis weights of the layers may be each independently, for example, 50 mg/cm² or less, 30 mg/cm² or less, 25 mg/cm² or less, 15 mg/cm² or less, or 10 mg/cm² or less.

Layers may each independently have any void ratio. The void ratios of the layers may be substantially the same or different from each other. For example, the void ratio “φ₁” of the first active material layer 22a, the void ratio “φ₂” of the second active material layer 22b, and the void ratio “φ₃” of the third active material layer 22c may satisfy a relationship of “φ₁<φ₃<φ₂” or the like. A ratio of the maximum void ratio to the minimum void ratio among the three layers may be, for example, 1.2 or more, 1.5 or more, 2 or more, or 2.5 or more. A ratio of the maximum void ratio to the minimum void ratio among the three layers may be, for example, 5 or less, 3 or less, or 2 or less. The void ratios of the layers may be each independently, for example, 1% or more, 5% or more, 10% or more, 20% or more, 30% or more, 40% or more, or 50% or more. The void ratios of the layers may be each independently, for example, 80% or less, 70% or less, 60% or less, 50% or less, 40% or less, 30% or less, 20% or less, 10% or less, or 5% or less.

### Negative Electrode Active Material

The first active material layer 22a is a lower layer. The first active material layer 22a may be directly provided on the surface of the current collector 21. The first active material layer 22a contains a first negative electrode active material. The first active material layer 22a may further contain a conductive material, a binder, and the like. The first active material layer 22a may contain, for example, in terms of mass fraction, 0% to 10% of a conductive material, 0% to 10% of a binder, and a first negative electrode active material as a remainder. The first active material layer 22a may contain, for example, in terms of mass fraction, 0.5% to 1.5% of a conductive material, 0.5% to 3% of a binder, and a first negative electrode active material as a remainder. The first negative electrode active material contains at least one of natural graphite or artificial graphite. The first negative electrode active material may, for example, consist of natural graphite.

The second active material layer 22b is a middle layer. The second active material layer 22b may be directly provided on the surface of the first active material layer 22a. The second active material layer 22b contains a second negative electrode active material. The second active material layer 22b may further contain a conductive material, a binder, and the like. The second active material layer 22b may contain, for example, in terms of mass fraction, 0% to 10% of a conductive material, 0% to 10% of a binder, and a second negative electrode active material as a remainder. The second active material layer 22b may contain, for example, in terms of mass fraction, 0.5% to 1.5% of a conductive material, 0.5% to 3% of a binder, and a second negative electrode active material as a remainder. The second negative electrode active material contains natural graphite and a Si-based active material. The negative electrode active material may consist of natural graphite and a Si-based active material. For example, a relationship of “Si-based active material/natural graphite=1/99 to 50/50”, “Si-based active material/natural graphite=1/99 to 30/70”, or the like may be satisfied in terms of mass ratio. Alternatively, a relationship of “Si-based active material/natural graphite=1/99 to 20/80”, “Si-based active material/natural graphite=1/99 to 10/90”, or the like may be satisfied in terms of mass ratio.

The third active material layer 22c is an upper layer. The third active material layer 22c may form the outermost surface of the negative electrode 20. The third active material layer 22c may be directly provided on the surface of the second active material layer 22b. The third active material layer 22c contains a third negative electrode active material. The third active material layer 22c may further contain a conductive material, a binder, and the like. The third active material layer 22c may contain, for example, in terms of mass fraction, 0% to 10% of a conductive material, 0% to 10% of a binder, and a third negative electrode active material as a remainder. The third active material layer 22c may contain, for example, in terms of mass fraction, 0.5% to 1.5% of a conductive material, 0.5% to 3% of a binder, and a third negative electrode active material as a remainder. The third negative electrode active material contains at least one of natural graphite or artificial graphite. The third negative electrode active material may, for example, consist of artificial graphite and natural graphite. For example, a relationship of “artificial graphite/natural graphite=1/99 to 50/50”, “artificial graphite/natural graphite=1/99 to 30/70”, or the like may be satisfied in terms of mass ratio. Alternatively, a relationship of “artificial graphite/natural graphite=1/99 to 20/80”, “artificial graphite/natural graphite=1/99 to 10/90”, or the like may be satisfied in terms of mass ratio.

The first negative electrode active material, the second negative electrode active material, and the third negative electrode active material may each independently further contain lithium titanate, an Sn-based alloy, SnO, pure Li, an Li-based alloy, or the like.

The first negative electrode active material, the second negative electrode active material, and the third negative electrode active material may each independently have any average particle diameter. The average particle diameter may be, for example, 1 μm or more, 5 μm or more, 10 μm or more, or 15 μm or more. The average particle diameter may be, for example, 30 μm or less, 20 μm or less, 15 μm or less, or 10 μm or less. For example, in a case of comparing the natural graphite and the Si-based active material, the natural graphite may be a large particle and the Si-based active material may be a small particle. For example, in a case of comparing the natural graphite and the artificial graphite, the natural graphite may be a large particle and the artificial graphite may be a small particle. A ratio of the average particle diameter of the large particle to the average particle diameter of the small particle may be, for example, 1 or more, 1.5 or more, 2 or more, 3 or more, 4 or more, or 5 or more. The ratio of the average particle diameter of the large particle to the average particle diameter of the small particle may be, for example, 10 or less, 8 or less, or 6 or less.

The natural graphite, the artificial graphite, and the Si-based active material may each independently have any particle shape. The particle shape may be, for example, spherical, ellipsoidal, flake-shaped, or flake-shaped. For example, the aspect ratio of the natural graphite may be larger than the aspect ratio of the artificial graphite and the Si-based active material. The aspect ratio of the natural graphite may be, for example, 1.2 or more, 1.5 or more, 1.8 or more, 2.1 or more, 2.4 or more, 3 or more, 4 or more, 5 or more, or 6 or more. The aspect ratio of the natural graphite may be, for example, 8 or less, 6 or less, 4 or less, or 3 or less. The aspect ratio of the artificial graphite and the aspect ratio of the Si-based active material may be each independently, for example, 2 or less, 1.5 or less, or 1.2 or less. The aspect ratio of the artificial graphite and the aspect ratio of the Si-based active material may be each independently, for example, 1 or more or 1.1 or more.

The natural graphite in the second active material layer 22b is aligned in the thickness direction. The natural graphite in the second active material layer 22b may have an alignment angle “θ₂” of 30° or more. The alignment angle “θ₂” may be, for example, 45° or more, 60° or more, or 75° or more. The alignment angle “θ₂” may be, for example, 90° or less, 75° or less, or 60° or less.

In the first active material layer 22a and the third active material layer 22c, the natural graphite may have any alignment angle. For example, the alignment angle “θ₁” in the first active material layer 22a, the alignment angle “θ₂” in the second active material layer 22b, and the alignment angle “θ₃” in the third active material layer 22c may satisfy a relationship of “θ₁<θ₃<θ₂”. The alignment angle “θ₁” may be, for example, 0° or more, 5° or more, 10° or more, or 15° or more. The alignment angle “θ₁” may be, for example, 20° or less or 15° or less. The alignment angle “θ₃” may be, for example, 15° or more, 20° or more, 25° or more, or 30° or more. The alignment angle “θ₃” may be, for example, 45° or less, 30° or less, or 25° or less.

### Binder

The binder may include, for example, styrene butadiene rubber (SBR), carboxymethyl cellulose (CMC), polyacrylic acid (PAA), or polytetrafluoroethylene (PTFE). The mass fraction of the binder between the layers may be substantially the same or different from each other. For example, a relationship of “M_{B3}<M_{B1}<M_{B2}” may be satisfied. “M_{B1}” indicates a mass fraction of the binder in the first active material layer 22a. “M_{B2}” indicates a mass fraction of the binder in the second active material layer 22b. “M_{B3}” indicates a mass fraction of the binder in the third active material layer 22c. The ratio “M_{B2}/M_{B1}” and the ratio “M_{B1}/M_{B3}” may be each independently, for example, 1.2 or more, 1.5 or more, 2 or more, or 2.5 or more. The ratio “M_{B2}/M_{B1}” and the ratio “M_{B1}/M_{B3}” may be each independently, for example, 3 or less or 2 or less.

For example, a binder layer 22d may be provided in at least one of “between the first active material layer 22a and the second active material layer 22b” or “between the second active material layer 22b and the third active material layer 22c”. A mass fraction of the binder in the binder layer 22d is higher than a mass fraction of the binder in the active material layer. The binder layer 22d may be a layer that substantially does not contain a negative electrode active material. The binder layer 22d may contain, for example, in terms of mass fraction, 0% to 10% of a conductive material, and a binder as a remainder. The binder layer 22d may contain, for example, in terms of mass fraction, 1% to 5% of a conductive material, and a binder as a remainder.

For example, the type of the binder may be the same between the layers. For example, the type of the binder may be different between the layers. For example, the binder in the binder layer 22d may include a resin that swells with an electrolytic solution. For example, the binder in the binder layer 22d may include a resin having ion permeability or a resin having ion conductivity. The improvement in the charge rate characteristics is expected by allowing the electrolytic solution and the Li ions to permeate the binder layer 22d. For example, the binder in the binder layer 22d may include a fibrous resin. The fibrous resin may extend to crosslink between the active material layers. By crosslinking between the active material layers with the fibrous resin, for example, the improvement in the peel strength is expected. The binder in the binder layer 22d may contain, for example, at least one selected from the group consisting of PAA, polyacrylic acid ester, CMC, alginic acid, polyvinylidene fluoride (PVDF), poly(vinylidene fluoride-co-hexafluoropropylene) (PVDF-HFP), and PTFE. For example, PAA, PVDF, PVDF-HFP, and the like may have swellability, ion permeability, or ion conductivity. For example, PTFE may be fibrous.

A thickness “T₄” of the binder layer 22d may be, for example, smaller than the thickness “T₁, T₂, T₃” of the active material layer. The thickness “T₄” of the binder layer 22d may be, for example, 10 μm or less, 5 μm or less, or 3 μm or less. The thickness “T₄” of the binder layer 22d may be, for example, 0.5 μm or more, 1 μm or more, or 3μm or more. A basis weight “W₄” of the binder layer 22d may be, for example, smaller than the basis weight “W₁, W₂, W₃” of the active material layer. The basis weight “W₄” of the binder layer 22d may be, for example, 5 mg/cm² or less, 3 mg/cm² or less, or 1 mg/cm² or less. The basis weight “W₄” of the binder layer 22d may be, for example, 0.1 mg/cm² or more or 0.5 mg/cm² or more.

### Conductive Material

The conductive material may include, for example, acetylene black, carbon nanotube (CNT), vapor-grown carbon fiber (VGCF). The mass fraction of the conductive material may be substantially constant over the entire region of the active material layer. The mass fraction of the conductive material may be locally different. For example, the mass fraction of the conductive material may be different between the layers. For example, the type of the conductive material may be different between the layers. For example, the binder layer 22d may include a fibrous conductive material. The binder layer 22d may include, for example, at least one selected from the group consisting of CNT and VGCF. The fibrous conductive material may extend to crosslink between the active material layers. By crosslinking between the active material layers with the fibrous conductive material, for example, the improvement in the charge rate characteristics and the reduction of the interlayer peeling are expected.

What is claimed is:

1. A negative electrode for a non-aqueous electrolyte secondary battery, the negative electrode comprising:
a current collector;
a first active material layer;
a second active material layer; and
a third active material layer, in an order of the current collector, the first active material layer, and the second active material layer, wherein:
the first active material layer and the third active material layer each independently contain at least one of natural graphite or artificial graphite;
the second active material layer contains natural graphite and a Si-based active material; and
the natural graphite in the second active material layer is aligned in a thickness direction of the second active material layer.

2. The negative electrode according to claim 1, wherein:
the natural graphite in the second active material layer has an alignment angle of 30° or more; and
the alignment angle indicates an acute angle between a major axis diameter of a particle and a surface of the current collector.

3. The negative electrode according to claim 2, wherein:
the first active material layer contains the natural graphite;
the third active material layer contains the artificial graphite and the natural graphite;
a relationship of θ₁<θ₃<θ₂ is satisfied;
θ₁ indicates an alignment angle of the natural graphite in the first active material layer;
θ₂ indicates an alignment angle of the natural graphite in the second active material layer; and
θ₃ indicates an alignment angle of the natural graphite in the third active material layer.

4. The negative electrode according to claim 1, wherein:
the first active material layer, the second active material layer, and the third active material layer each independently further contain a binder;
a relationship of M_{B3}<M_{B1}<M_{B2} is satisfied;
M_{B1} indicates a mass fraction of the binder in the first active material layer;
M_{B2} indicates a mass fraction of the binder in the second active material layer; and
M_{B3} indicates a mass fraction of the binder in the third active material layer.

5. A negative electrode for a non-aqueous electrolyte secondary battery, the negative electrode comprising:
a current collector;
a first active material layer;
a second active material layer; and
a third active material layer, in an order of the current collector, the first active material layer, and the second active material layer, wherein:
the first active material layer contains natural graphite and a binder;
the second active material layer contains natural graphite, a Si-based active material, and a binder;
the third active material layer contains artificial graphite, natural graphite, and a binder;
the natural graphite in the second active material layer has an alignment angle of 30° or more;
the alignment angle indicates an acute angle between a major axis diameter of a particle and a surface of the current collector;
a relationship of θ₁<θ₃<θ₂ is satisfied;
θ₁ indicates an alignment angle of the natural graphite in the first active material layer;
θ₂ indicates an alignment angle of the natural graphite in the second active material layer;
θ₃ indicates an alignment angle of the natural graphite in the third active material layer;
a relationship of M_{B3}<M_{B1}<M_{B2} is satisfied;
M_{B1} indicates a mass fraction of the binder in the first active material layer;
M_{B2} indicates a mass fraction of the binder in the second active material layer;
M_{B3} indicates a mass fraction of the binder in the third active material layer;
a relationship of φ₁<φ₃<φ₂ is satisfied;
φ₁ indicates a void ratio of the first active material layer;
φ₂ indicates a void ratio of the second active material layer; and
φ₃ indicates a void ratio of the third active material layer.
